(19) United States
(12) Patent Application Publication
(10) Pub. No.: US 2010/0313701 A1
(43) Pub. Date: Dec. 16, 2010

(54) HEAD-RISING MECHANISM

(75) Inventor: Weizeng Lu, Fujian (CN)

Correspondence Address: RABIN & Berdo, PC, 1101 14TH STREET, NW, SUITE 500, WASHINGTON, DC, 20005, US

(73) Assignee: Tsann Kuen(China) Enterprise Co., Ltd., Fujian (CN)

(21) Appl. No.: 12/867,517

(22) PCT Filed: Feb. 13, 2009
(86) PCT No.: PCT/CN09/70415

§ 371 Date: Aug. 13, 2010

(30) Foreign Application Priority Data
Feb. 15, 2008 (CN) 200820101429

(51) Int. Cl. G05G 5/06

(52) U.S. Cl. 74/527

(57) ABSTRACT

The head-rising mechanism is set between a main body and a head that is rotated around and connected to the main body. The head-rising mechanism has a supporting plate fixed to the main body, a head-rising bolt, a button element and a connecting shank. The bolt is connected with the plate by sliding along an axis direction and is equipped with a control surface that slopes along an axis direction and a giving way notch. The button is connected to the plate by sliding along an axis direction and leans against the head-rising bolt and can be reposited automatically. The shank is fixed to the head and has lower end surface equipped with a work state recess, a head-rising recess and a middle portion that is set between the work recess and the head-rising recess and can freely pass through the notch when the button is pressed.

### FIELD OF THE INVENTION

The present invention relates to a head-rising mechanism of an electric appliance, especially relates to a head-rising mechanism of an electric coffee pot, a food processor or a water boiler.

### BACKGROUND OF THE INVENTION

There are many kinds of household appliances in the market, for example: electric coffee pots, food processors or water boilers, and so on. They all comprise a main body, a head and a head-rising mechanism, said head is rotated around and connected with said main body, said head-rising mechanism is disposed between said main body and said head, so said head can has a work state and a head-rising state with respect to the main body. However, the existing head-rising mechanism has the following shortcomings: firstly, the demand for manufacturing precision is relatively high, so the manufacturing cost is relatively high; secondly, the structural stability is poor and it will be easy to lose efficacy after long working time, the head will shake seriously, so the working efficiency will be lower and the visual effects of the consumer will be affected.

### SUMMARY OF THE INVENTION

The objective of the present invention is to provide a head-rising mechanism, which overcomes the shortcomings of the conventional head-rising mechanism such as high demand for manufacturing precision, poor structural stability and loss of efficacy after long working time.

The first technical solution applied by the present invention is:

A head-rising mechanism, which is set between a main body and a head that is rotated around and connected with the main body, said head has a work state and a head-rising state with respect to said main body, said head-rising mechanism comprises:

a supporting plate that is fixed to said main body;
a head-rising bolt that is connected with said supporting plate by sliding along axis direction and equipped with a control surface that slopes along axis direction and a giving way notch; a button element is connected with the supporting plate by sliding along axis direction and is leaned against the head-rising bolt and can be reposited automatically; and
a connecting shank is fixed to said head and its lower end surface equipped with a work recess corresponding to the work state, a head-rising recess corresponding to the head-rising state and a middle portion that is set between the work recess and the head-rising recess and can freely pass through said giving way notch when the button element is pressed, said work recess or said head-rising recess is leaned against the control surface selectively.

In a preferred embodiment, the disposal direction of said work recess of said connecting shank, said middle portion and said head-rising recess is vertical to the sliding direction of said head-rising bolt.

In a preferred embodiment, wherein said control surface of said head-rising bolt is a sloping surface with a narrow front portion and a broad rear portion, said giving way notch is set in front of said control surface.

In a preferred embodiment, said button element comprises a button leaned against the front end surface of said head-rising blot and a reset spring set on the rear end surface of said head-rising bolt.

In a preferred embodiment, the sloping angle of said control surface of said head-rising blot is ranges from 5 degrees to 20 degrees.

In a preferred embodiment, said head-rising bolt is shaft-shaped, further said control surface is a circumferential surface of a circular truncated cone.

In a preferred embodiment, said head-rising bolt is truncated cone-shaped, which comprises a platform and a protruding block, said control surface is set on said protruding block.

The second technical solution applied by the present invention is:

A head-rising mechanism, which is set between a main body and a head that is rotated around and connected with the main body, said head has a work state and a head-rising state with respect to said main body, said head-rising mechanism comprises:

a supporting plate that is fixed to said main body;
a head-rising bolt that is connected with said supporting plate by sliding along axis direction and equipped with a control surface that slopes along axis direction and a giving way notch; a reposition element that is leaned against said head-rising bolt; and
a connecting shank is fixed to said head and its lower end surface equipped with a work recess corresponding to the work state, a head-rising recess corresponding to the head-rising state and a middle portion that is set between the work recess and the head-rising recess and can freely pass through said giving way notch when the head-rising bolt is pressed, said work recess or said head-rising recess is leaned against the control surface selectively.

In a preferred embodiment, the disposal direction of said work recess of said connecting shank, said middle portion and said head-rising recess is vertical to the sliding direction of said head-rising bolt.

In a preferred embodiment, it further comprises a button element installed on said head-rising bolt and connected with said supporting plate by sliding along axis direction.

Compared to the background technique: when the consumer presses the button element, the head-rising bolt will be driven to slide to make the giving way notch align with the middle portion of the connecting shank, so the head will rotate freely, releases the button element when it rotates to a needed state, the spring will drive the head-rising bolt reposit, meanwhile the sloping control surface will drive the control surface fixed and abutted against the work recess or the head-rising recess, that is the head is in the work state or head-rising state selectively, thereby the shortages of the background technique are overcome, and it has such advantages: firstly, since the control surfaces of the mechanism are sloping, so the cooperation of sloping surfaces can greatly reduce the demand for manufacturing precision, cut down the manufacturing cost, and greatly promote the mechanism stability; secondly, since the control surfaces of the mechanism are sloping, the cooperation of sloping surfaces will solve the problems caused by structure abrasion, burrs and roughness generated during the manufacture process. The control surfaces will be polished after running for a certain time, the cooperation of the structure is more stable. After the mechanism is manufactured, the demand for manufacturing precision of connecting shank, head-rising bolt and supporting plate is not too high, the sloping surfaces needn't close to each other completely and tightly when three parts cooperate with each other, after said mechanism running for a certain time, the cooperating sloping surfaces between the three parts will be polished more smoothly. So the cooperation will be tighter and thus the mechanism is more stable.

### BRIEF DESCRIPTION OF THE DRAWINGS

The present invention will become apparent with the reference of the accompanying drawings and the preferred embodiments.

FIG. 1 is the schematic view of the household appliance of the first embodiment when it is in work state.

FIG. 2 is the schematic view of the household appliance of the first embodiment when it is in head-rising state.

FIG. 3 is the exploded structural view of the head-rising mechanism of the first embodiment.

FIG. 4 is the perspective view of the head-rising mechanism of the first embodiment when it is in work state.

FIG. 5 is the perspective view of the head-rising mechanism of the first embodiment when it is in head-rising state.

FIG. 6 is the sectional view of the head-rising mechanism of the first embodiment when it is in work state.

FIG. 7 is the perspective view of the head-rising mechanism of the second embodiment.

### DETAILED DESCRIPTION OF THE EMBODIMENTS

### Embodiment 1

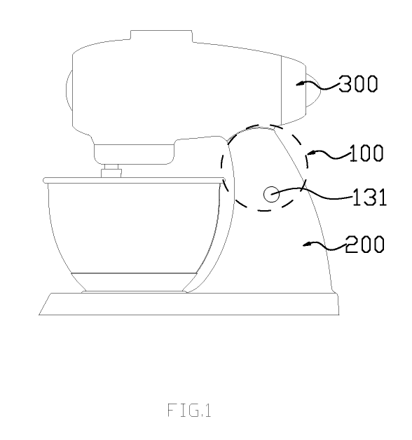

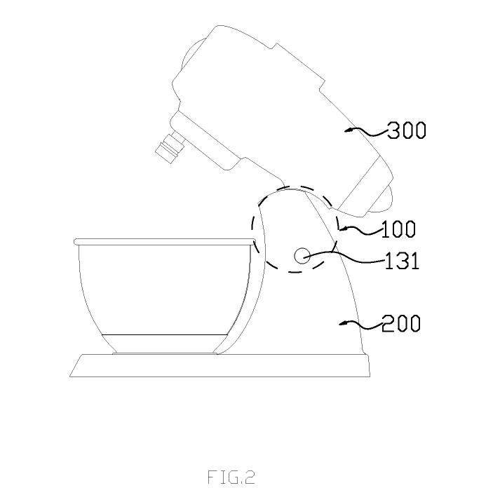

Please refer to FIG. 1 and FIG. 2, a household appliance, such as electric coffee pot, food processor or water boiler, and so on. It comprises a main body 200, a head 300 and a head-rising mechanism 100, said head 300 is pivoted to said main body 200 and rotated around and connected with the main body, said head-rising mechanism 100 is connected between said main body 200 and the said head 300, so said head 300 can rotate corresponding to the main body 200 and be fixed in work state and head-rising state.

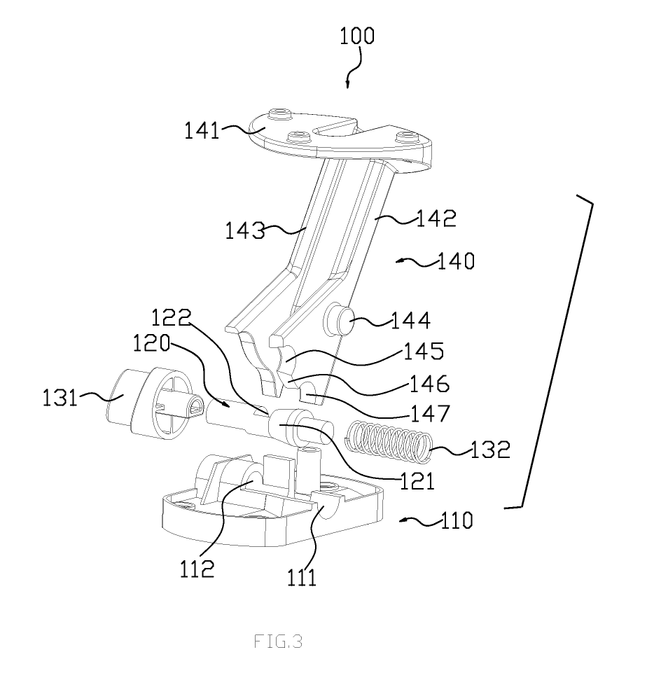

Please refer to FIG. 3, said head-rising mechanism 100 comprises a supporting plate 110, a head-rising bolt 120, a button element and a connecting shank 140.

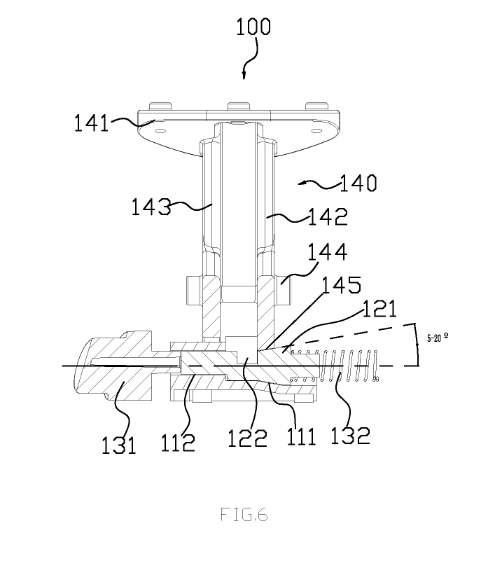

Please refer to FIG. 3 and FIG. 6, said supporting plate 110 comprises a fixed seat fixed to the main body 200. Said fixed seat has a base seat recess 111 which has a base seat surface. Moreover, said fixed seat has a sliding recess 112.

Please refer to FIG. 3 and FIG. 6, said head-rising bolt 120 is shaft-shaped, which protrudes upward and has a protruding ring 121, the circumferential surface of said protruding ring 121 is designed as a sloping control surface of a circular truncated cone which is narrow in front portion and broad in rear portion, said sloping angle is ranged from 5 degree to 20 degree, so 7 degree can be applied. The front of the protruding ring 121 of said head-rising bolt 120 has a giving way notch 122. Said head-rising bolt 120 is slidabably connected with the sliding recess 112 of the fixed seat, further, the lower part of the control surface of the circular truncated cone is fit to abutted against the base seat surface of the base seat recess 111.

Please refer to FIG. 3 and FIG. 6, said button element comprises a button 131 leaned against the front end surface of the head-rising bolt 120 and a reset spring 132 installed on the supporting plate 110 and the rear end surface of the head-rising bolt 120. The reset spring 132 is used to realize the reposition of the button element and the head-rising bolt 120, so the connecting shank 140, the supporting plate 110 and the head-rising bolt 120 can cooperate with each other tightly.

Please refer to FIG. 3 and FIG. 6, said connecting shank 140 comprises an installing seat 141 fixed under the head 300. A control element 142 and a supporting element 143 are integrated under said installing seat 141 as one body. Two pivots 144 are respectively disposed on said supporting element 143 and the control element 142, the head 300 is pivoted with the main body 200 with said two pivots 144. Said supporting element 143 can support and freely slide along said head-rising bolt 120; the lower end surface of said control element 142 is sequentially disposed with a head-rising recess 145, a middle portion 146 and a work recess 147 from left to right, said middle portion 146 is set between the work recess 147 and the head-rising recess 145 and can align with said giving way notch 122 and then freely pass through said giving way notch 122 when the button 131 is pressed. The work recess surface of said work recess 147 and the head-rising recess surface of the head-rising recess 145 are all adapted to the upper part of the control surface of the circular truncated cone of the protruding ring 121.

The head-rising mechanism has two states such as work state and head-rising state.

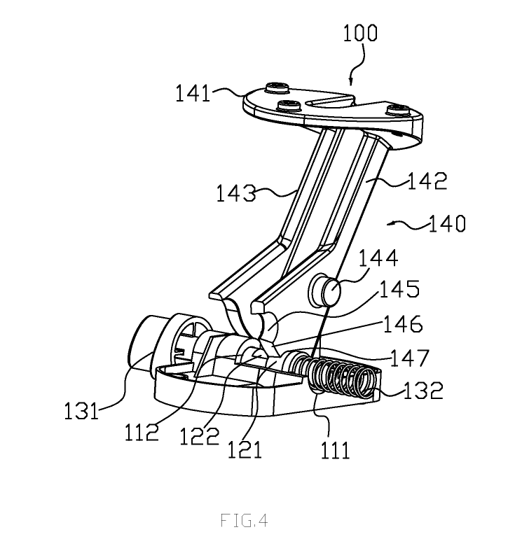

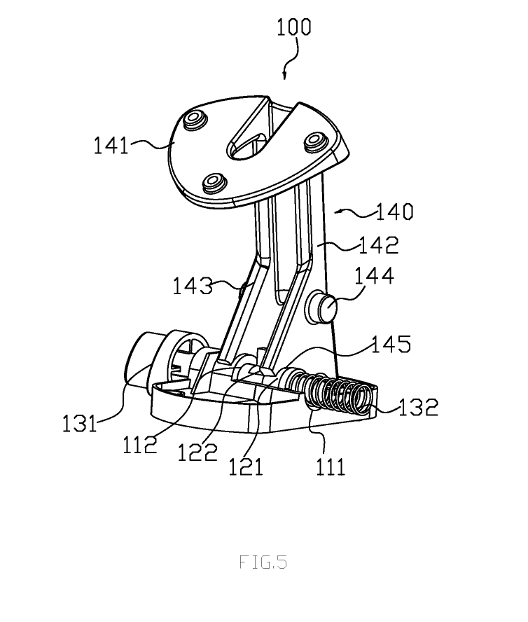

During the work state, the sloping surface of the control surface of the protruding ring 121 of the head-rising bolt 120, the work recess surface of the work recess 147 of the connecting shank 140 and the base seat surface of the base seat recess 111 of the supporting plate 110 are abutted against each other tightly, please refer to FIG. 4. When the button 131 is pressed, the button 131 will move backward, the head-rising bolt 120 will move backward, too. When the giving way notch 122 shifts just below the work recess surface of the work recess 147, the middle portion 146 of the connecting shank 140 can freely pass through the giving way notch 122, so the connecting shank 140 can keep away from the head-rising bolt 120, so the head 300 can rotate freely, the head 300 can be lifted upward. After the head 300 is lifted upward, the button 131 and the head-rising bolt 120 will reposit to the original position due to the spring 132, at this time the sloping surface of the control surface of the protruding ring 121 of the head-rising bolt 120 cooperates with the head-rising recess surface of the head-rising recess 145 of the connecting shank 140, so the head-rising bolt 120 is fixed in the head-rising state, as showed in FIG. 5.

During the head-rising state: the sloping surface of the control surface of the protruding ring 121 of the head-rising bolt 120, the head-rising recess surface of the head-rising recess 145 of the connecting shank 140 and the base seat surface of the base seat recess 111 of the supporting plate 110 are abutted against each other tightly, please refer to FIG. 5. When the button 131 is pressed, the button 131 will move backward, the head-rising bolt 120 will move backward, too. When the giving way notch 122 shifts just below the head-rising recess surface of the head-rising recess 145, the middle portion 146 of the connecting shank 140 can freely pass through the giving way notch 122, so the connecting shank 140 can keep away from the head-rising bolt 120, so the head 300 can rotate freely, the head 300 can be put down. After the head 300 is put down, the button 131 and the head-rising bolt 120 will reposit to the original position due to the spring 132, at this time the sloping surface of the control surface of the protruding ring 121 of the head-rising bolt 120 cooperates with the work recess surface of the work recess 147 of the connecting shank 140, so the head-rising bolt 120 is fixed in the work state, as showed in FIG. 4.

### Embodiment 2

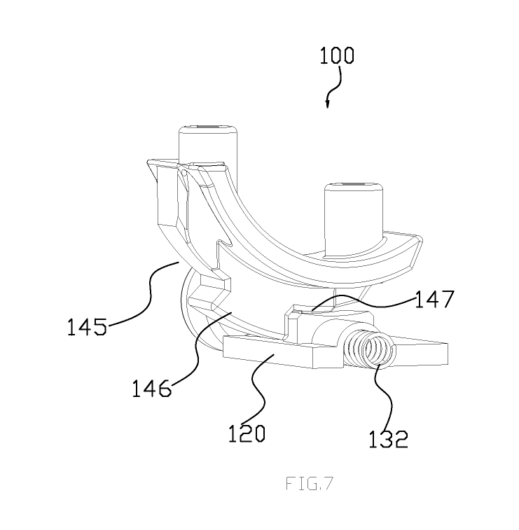

The difference between the first embodiment and the second embodiment is: please refer to FIG. 7, said head-rising bolt 120 is not shaft-shaped, but it is a truncated cone shape, said head-rising bolt 120 comprises a platform and a protruding block, said control surface is set on said protruding block.

### INDUSTRIAL APPLICABILITY

The present mechanism has sloping feature, the cooperation of the sloping surfaces will greatly reduce the demand for manufacturing precision and cost and the mechanism stability is greatly promoted. Secondly, the control surfaces of the present mechanism are sloping, the cooperation between the sloping surfaces can solve the problems caused by structure abrasion, burrs and roughness generated during the manufacturing process will be polished after running for a certain time, the cooperation of the structure is more stable. After the mechanism is manufactured, the demand for manufacturing precision of connecting shank, head-rising bolt and supporting plate is not too high, the sloping surfaces needn't close to each other completely and tightly when three parts cooperate with each other, after said mechanism running for a certain time, the cooperating sloping surfaces between the three parts will be polished more smooth. The cooperation will be tighter, and thus the mechanism is more stable.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

1. A head-rising mechanism, which is set between a main body and a head that is rotated around and connected with the main body, said head has a work state and a head-rising state with respect to said main body, wherein said head-rising mechanism comprises:
a supporting plate that is fixed to said main body;
a head-rising bolt that is connected with said supporting plate by sliding along axis direction and equipped with a control surface that slopes along axis direction and a giving way notch;
a button element is connected with the supporting plate by sliding along axis direction and is leaned against the head-rising bolt and can be reposited automatically; and
a connecting shank is fixed to said head and its lower end surface equipped with a work recess corresponding to the work state, a head-rising recess corresponding to the head-rising state and a middle portion that is set between the work recess and the head-rising recess and can freely pass through said giving way notch when the button element is pressed, said work recess or said head-rising recess is leaned against the control surface selectively.

2. The head-rising mechanism according to claim 1, wherein the disposal direction of said work recess of said connecting shank, said middle portion and said head-rising recess is vertical to the sliding direction of said head-rising bolt.

3. The head-rising mechanism according to claim 2, wherein said control surface of said head-rising bolt is a sloping surface with a narrow front portion and a broad rear portion, said giving way notch is set in front of said control surface.

4. The head-rising mechanism according to claim 3, wherein said button element comprises a button leaned against the front end surface of said head-rising blot and a reset spring set on the rear end surface of said head-rising bolt.

5. The head-rising mechanism according to claim 1, wherein the sloping angle of said control surface of said head-rising blot is ranges from 5 degrees to 20 degrees.

6. The head-rising mechanism according to claim 1, wherein said head-rising bolt is shaft-shaped, further said control surface is a circumferential surface of a circular truncated cone.

7. The head-rising mechanism according to claim 1, wherein said head-rising bolt is truncated cone-shaped, which comprises a platform and a protruding block, said control surface is set on said protruding block.

8. A head-rising mechanism, which is set between a main body and a head that is rotated around and connected with the main body, said head has a work state and a head-rising state with respect to said main body, wherein said head-rising mechanism comprises:
a supporting plate that is fixed to said main body;
a head-rising bolt that is connected with said supporting plate by sliding along axis direction and equipped with a control surface that slopes along axis direction and a giving way notch;
a reposition element that is leaned against said head-rising bolt; and
a connecting shank is fixed to said head and its lower end surface equipped with a work recess corresponding to the work state, a head-rising recess corresponding to the head-rising state and a middle portion that is set between the work recess and the head-rising recess and can freely pass through said giving way notch when the head-rising bolt is pressed, said work recess or said head-rising recess is leaned against the control surface selectively.

9. The head-rising mechanism according to claim 8, wherein the disposal direction of said work recess of said connecting shank, said middle portion and said head-rising recess is vertical to the sliding direction of said head-rising bolt.

10. The head-rising mechanism according to claim 8, wherein it further comprises a button element installed on said head-rising bolt and connected with said supporting plate by sliding along axis direction.

11. The head-rising mechanism according to claim 2, wherein the sloping angle of said control surface of said head-rising blot is ranges from 5 degrees to 20 degrees.

12. The head-rising mechanism according to claim 3, wherein the sloping angle of said control surface of said head-rising blot is ranges from 5 degrees to 20 degrees.

13. The head-rising mechanism according to claim 4, wherein the sloping angle of said control surface of said head-rising blot is ranges from 5 degrees to 20 degrees.

14. The head-rising mechanism according to claim 2, wherein said head-rising bolt is shaft-shaped, further said control surface is a circumferential surface of a circular truncated cone.

15. The head-rising mechanism according to claim 3, wherein said head-rising bolt is shaft-shaped, further said control surface is a circumferential surface of a circular truncated cone.

16. The head-rising mechanism according to claim 4, wherein said head-rising bolt is shaft-shaped, further said control surface is a circumferential surface of a circular truncated cone.

17. The head-rising mechanism according to claim 2, wherein said head-rising bolt is truncated cone-shaped, which comprises a platform and a protruding block, said control surface is set on said protruding block.

18. The head-rising mechanism according to claim 3, wherein said head-rising bolt is truncated cone-shaped, which comprises a platform and a protruding block, said control surface is set on said protruding block.

19. The head-rising mechanism according to claim 4, wherein said head-rising bolt is truncated cone-shaped, which comprises a platform and a protruding block, said control surface is set on said protruding block.

20. The head-rising mechanism according to claim 9, wherein it further comprises a button element installed on said head-rising bolt and connected with said supporting plate by sliding along axis direction.
